(19) United States
(12) Patent Application Publication
(10) Pub. No.: US 2022/0248639 A1
(43) Pub. Date: Aug. 11, 2022

(54) WOBBLING PET TREAT TOY AND DISPENSER

(71) Applicants: Nina Ingela Ottosson, Karlskoga (SE); Graham Geil Wilson, Denver, CO (US)

(72) Inventors: Nina Ingela Ottosson, Karlskoga (SE); Graham Geil Wilson, Denver, CO (US)

(21) Appl. No.: 17/169,205

(22) Filed: Feb. 5, 2021

(51) Int. Cl. A01K 15/02; A63F 7/04; A01K 5/02

(52) U.S. Cl. CPC A01K 15/025; A01K 5/02; A63F 7/041

(57) ABSTRACT

The invention comprises a novel pet toy and treat dispenser where inserted treats have to travel through a maze in order to be ejected out one of six openings. The bottom section is rounded so that it will rock and wobble. The top is transparent so the pet can see the treats, but they do not fall into any cracks or crevices for the humans to clean.

### FIELD

The invention relates to a novel pet puzzle toy and food dispenser in which treats are inserted through a top opening into a labyrinthian maze wherein retrieval requires the pet to rock the dispenser to cause treats to travel through a maze and be ejected from one of six openings.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet toy and treat dispenser where inserted treats are obtained when a pet manipulates the dispenser so that treats go through a maze within the dispenser and finally out of one of multiple exit orifices.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus, it is key to provide the pet with interesting toys.

### SUMMARY, OBJECTS AND ADVANTAGES

In working households, pets are often at home all day and require stimulation as well as food and water. The inventive toy and dispenser offers extended distraction for a pet as well as a method to retrieve treats.

With the inventive toy and dispenser, a solid bottom half is rounded so that the toy and dispenser will maintain movement in response to any manipulation from the pet, and treats will not gall into the base and potentially be stuck therein. A clear top portion allows visualization of treats as well as a method for filling the dispenser.

Between the rounded bottom half and clear top or cover piece resides a maze portion in the form of a labyrinth that treats must travel through and be ejected from one of six openings in the top. The pet has to resolve the mechanics of that action so that treats will be ejected from one of the exit openings in the dispenser and should learn to repeat the action to retrieve the treats.

Additionally, the sound of treats traveling through the maze portion add interest for the pet and will ultimately remain in memory as a rewarding activity. The pet hears the treats in the maze and will remember that with manipulation, it can cause treats to exit the toy and dispenser.

### BRIEF DESCRIPTION OF THE DRAWINGS

The invention is described in further detail by reference to three (3) drawings sufficient in detail to describe the invention in which:

FIG. 1 is a top view of the toy wherein the maze is visible through the clear top;

FIG. 2 is side perspective showing the layers of the toy and dispenser; and

FIG. 3 is an exploded view of the three portions of the toy and dispenser.

### DETAILED DESCRIPTION, INCLUDING BEST MODES OF CARRYING OUT THE INVENTION

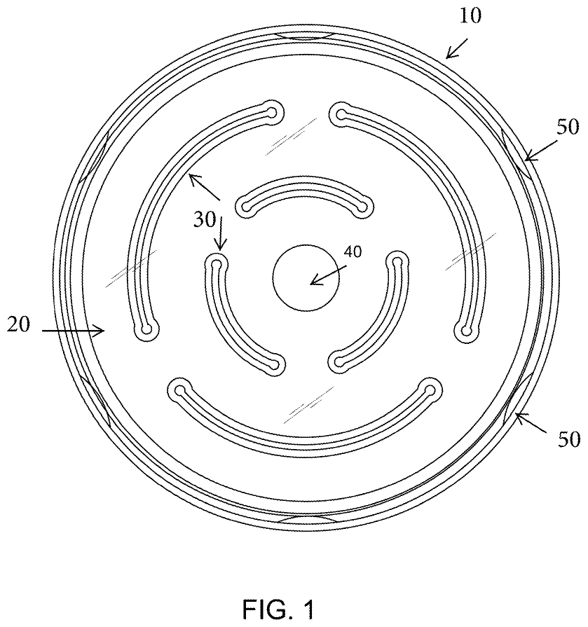

FIG. 1 illustrates the body of the toy and dispenser as assembled 10. A clear 20 cover is affixed by a snap-fit of the clear cover or top to the base piece and maze section 30. An opening in the top 40 allows treats to be inserted so that they will rest randomly in the maze section. Six openings 50 around the first edge of the toy and dispenser allows treats to be ejected when the pet manipulates the toy and dispenser causing it to rock.

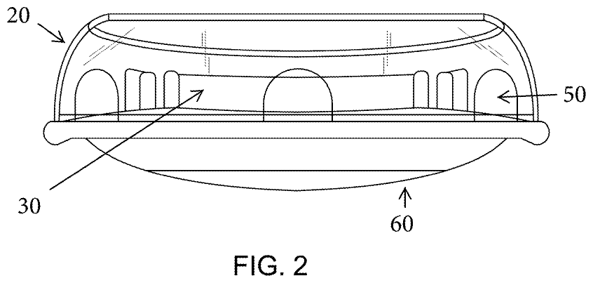

FIG. 2 is a side perspective of the toy and dispenser, now showing the solid base piece 60. The base is solid so that there is weight to the dispenser as well as keeping treats from falling inside and potentially being lodged in. The clear top section is again shown 20 and the six openings in the side of the dispenser at the attachment point of the top and bottom sections 50. When a pet manipulates the toy and dispenser, treats will travel though the maze section 30 and be ejected from the openings.

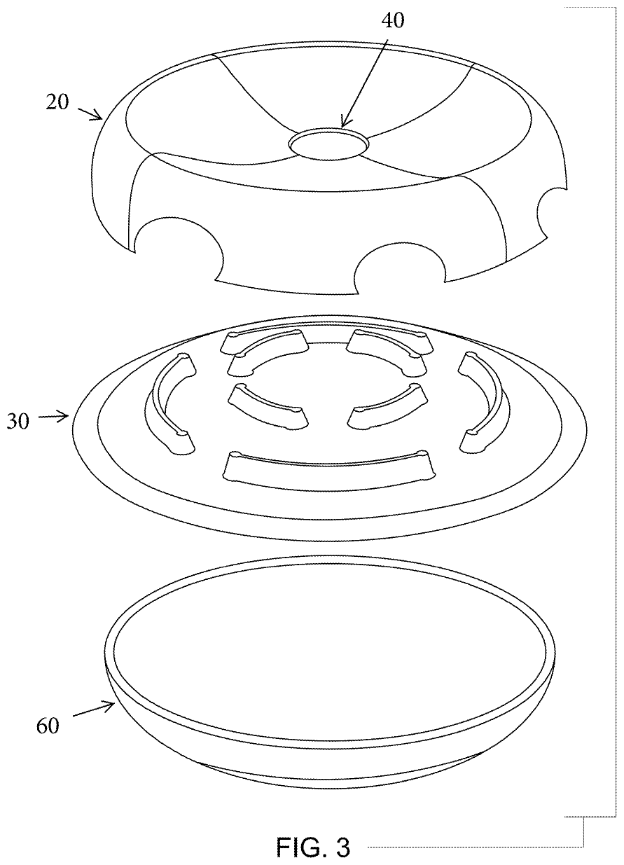

FIG. 3 is an exploded view showing the solid base section 60, the maze section 30 as it is snap fit to the base section, and the clear top or cover portion 20 wherein the user and the pet can see treats in the maze. The opening in the top of the clear cover section allows treats to be inserted to randomly rest in sections of the maze. The pet then has to manipulate the toy and dispenser so that treats travel though the maze section to find an exit from one of the six exit openings.

1 A three-piece pet toy and treat dispenser comprising;
a) a solid rounded bottom section
b) removable center maze section
c) a clear top section
d) six openings in the top section side
e) one centered top orifice for filling the toy and treat dispenser.

2) A three-piece pet toy and treat dispenser as in claim 1 wherein the bottom section is rounded on its base and is solid with no indentation in the section.

3) A three-piece pet toy and treat dispenser as in claim 1 wherein a removeable center section that snaps to the base piece and comprises a maze of avenues wherein treats will travel when manipulated by a pet.

4) A three-piece pet toy and treat dispenser as in claim 1 wherein a clear top section that snaps to the maze and bottom sections contains six side openings for treats to be ejected from, and a single opening in the top for inserting treats.
